(19) United States
(12) Patent Application Publication
(10) Pub. No.: US 2006/0036804 A1
(43) Pub. Date: Feb. 16, 2006

(54) Nonvolatile memory system

(75) Inventors: Shigemasa Shiota, Tachikawa (JP); Hiroyuki Goto, Higashimurayama (JP); Hirofumi Shibuya, Matsuda (JP); Fumio Hara, Higashikurume (JP); Yasuhiro Nakamura, Tachikawa (JP)

Correspondence Address: MILES & STOCKBRIDGE PC, 1751 PINNACLE DRIVE, SUITE 500, MCLEAN, VA, 22102-3833, US

(73) Assignees: Renesas Technology Corp.; Hitachi ULSI Systems Co., Ltd.

(21) Appl. No.: 11/246,074

(22) Filed: Oct. 11, 2005

Related U.S. Application Data
(63) Continuation of application No. 10/337,314, filed on Jan. 7, 2003.

(30) Foreign Application Priority Data
Feb. 7, 2002 (JP) 2002-030190

(51) Int. Cl. G06F 12/00

(52) U.S. Cl. 711/103; 711/156

(57) ABSTRACT

To prevent stored information from being changed even at the occurrence of an abnormal condition in an upstream side of a system due to uncontrollable run of an OS. A nonvolatile storage means having data storage areas and management areas for them in units of predetermined physical addresses has an access protect definition table TLB in a predetermined physical address, and the table has access attribute information defining whether to permit or not access to the data storage areas in association with the physical addresses. The memory system itself possesses access attribute information defining whether to permit or not a write to and a read from the data storage areas in association with addresses to implement an access protect function for write and read. Therefore, the access protect function is maintained even if an abnormal condition occurs in a host device that manages the memory system or controls it as a peripheral circuit.

### BACKGROUND OF THE INVENTION

The present invention relates to memory systems such as flash memory cards or hard disk units, and more particularly to write protection and read protection for them. It relates to technologies effectively applied to file memory systems compatible with, e.g., hard disk units.

Write protection for flash memory cards, hard disk units, and the like can be performed by an OS (operating system) of a host device for them. For example, in a case where write protection is performed through file access management of the OS, when a write request for a write-protected file is made, the file management function of the OS rejects the write request. In short, write protection for stored information for a memory system is performed by software in an upstream or superior side managing the memory system.

### SUMMARY OF THE INVENTION

However, even if write protection for stored information for a memory system is performed by software in an upstream or superior side of a system such as an OS, if the CPU becomes uncontrollable, the software-based write protect function is lost and undesirable write and erase operations are performed due to an abnormal condition of the OS, as a result of which stored information on the memory would be readily changed.

Some application fields require read protection from the viewpoint of security. An example is a voice recorder installed in an airplane. Read protection for it is also the same as write protection, in that even if read protection for stored information for a memory system is performed by software in an upstream or superior side of a system such as an OS, if the CPU becomes uncontrollable, the software-based read protect function is lost and stored information on the memory may be undesirably read. In another case, if a flash memory file system is removed from the voice recorder and connected to a different host system, recorded information may be freely read.

With regard to a memory system such as a file system, access protection such as conventional write protection and read protection is generally performed on a file basis. A demand to protect part of a file cannot be satisfied.

An object of the present invention is to provide a memory system that can significantly reduce the possibility that stored information is undesirably changed even at the occurrence of an abnormal condition in an upstream or superior side of a system such as an OS.

An object of the present invention is to provide a memory system that can significantly reduce the possibility that stored information is undesirably read even at the occurrence of an abnormal condition in an upstream or superior side of a system such as an OS.

Yet another object of the present invention is to provide a memory system that can apply access protection to part of a file or the like.

The foregoing and other objects and novel characteristics of the present invention will become apparent from the present specification and the accompanying drawings.

Typical inventions disclosed in the present patent application will be briefly described below.

(1) The memory system includes a nonvolatile storage means having data storage areas and management areas for them in units of predetermined physical addresses, and a control means for controlling access to the nonvolatile storage means in response to requests issued from the outside of the memory system. The nonvolatile storage means has an access protect definition table in a predetermined physical address, and the table has access attribute information defining whether to permit or not access to the data storage areas in association with the physical addresses. The access control means can modify the access protect definition table in response to a request to modify the access attribute information, issued from the outside of the memory system. The nonvolatile storage means is an electrically erasable and programmable semiconductor nonvolatile memory, e.g., a flash memory.

As has been described above, the memory system itself has the access protect function such as write protection and read protection. The access protect function is maintained even if an abnormal condition occurs in a host device or host system that manages the memory system or controls it as a peripheral circuit. Even if the system or OS becomes uncontrollable due to an abnormal condition of the host device or host system and undesirable write and erase requests are issued, if an instruction to reset the access protect function is not made at the same time, the undesirable write and erase requests are not executed. The above described write protection helps to significantly reduce the possibility that stored information is undesirably changed due to an abnormal condition in an upstream or superior side of a system such as an OS. The above described read protection helps to significantly reduce the possibility that stored information is undesirably read due to an abnormal condition in an upstream or superior side of a system such as an OS. Furthermore, since the access protect definition table defines whether to permit or not access to data storage areas in association with physical addresses, access protection can be applied not only on a file basis but also to part of files and the like.

With regard to write protection as a concrete embodiment of the present invention, the access protect definition table has, as the access attribute information, attribute information on write protection indicating whether a write is enabled or disabled for each of physical addresses. As another embodiment, the access protect definition table has, as the access attribute information, address information of write-enabled physical addresses. As yet another embodiment, the access protect definition table has, as the access attribute information, address information of write-disabled physical addresses.

With regard to read protection, the access protect definition table has, as the access attribute information, attribute information on read protection indicating whether a read is enabled or disabled for each of physical addresses. As another embodiment, the access protect definition table has, as the access attribute information, address information of read-enabled physical addresses. As yet another embodiment, the access protect definition table has, as the access attribute information, address information of read-disabled physical addresses.

(2) According to yet another aspect of the present invention, the memory system is provided with not the access protect definition table but access attribute information defining whether to permit or not access to corresponding data storage areas. The access control means can modify the access attribute information in response to a request to modify the access attribute information, issued from the outside of the memory system.

As in the case where the access protect definition table is used, the memory system itself has the access protect function such as write protection and read protection. Therefore, the write protection helps to significantly reduce the possibility that stored information is undesirably changed due to an abnormal condition in an upstream or superior side of a system such as an OS. The read protection helps to significantly reduce the possibility that stored information is undesirably read due to an abnormal condition in an upstream or superior side of a system such as an OS. Furthermore, since the access protect definition table defines whether to permit or not access to data storage areas in association with physical addresses, access protection can be applied not only on a file basis but also to part of files and the like.

A description is made of comparison with the use of the access protect definition table. When management areas of individual physical addresses in a nonvolatile storage means are provided with attribute information for access protection to check the setting of access protection for the nonvolatile storage means, all the physical addresses must be accessed for the checking. On the other hand, in cases where the access protect definition table is used, efficiently, the table has only to be accessed.

With regard to write protection as a concrete embodiment of the present invention, the access attribute information is attribute information indicating whether a write is enabled or disabled. The access attribute information may be attribute information indicating whether a read is enabled or disabled.

### BRIEF DESCRIPTION OF THE DRAWINGS

FIG. 1 is a block diagram showing a flash memory card as an example of a memory system according to the present invention;

FIG. 2 illustrates an example of a write area registration table;

FIG. 3 illustrates another example of the write area registration table;

FIG. 4 illustrates another example of the write area registration table;

FIG. 5 illustrates details of a processing flow of modifying the write area registration table;

FIG. 6 illustrates a processing flow of modifying a write-enabled data area (k-1);

FIG. 7 illustrates a processing flow of modifying a write-disabled data area (k);

FIG. 8 illustrates a processing flow of read operation when the read protect function using the write area registration table is not provided;

FIG. 9 illustrates a processing flow of reading a read-enabled data area (k-1) when the read protect function using the write area registration table is provided;

FIG. 10 illustrates a processing flow of reading a read-disabled data area (k) when the read protect function using the write area registration table is provided;

FIG. 11 is a block diagram showing a flash memory card as another example of the memory system of the present invention;

FIG. 12 illustrates a processing flow of modifying write attribute information when the flash memory card of FIG. 11 is used;

FIG. 13 illustrates a processing flow of modifying a write-enabled data area (k-1) when the flash memory card of FIG. 11 is used;

FIG. 14 illustrates a processing flow of modifying a write-disabled data area (k) when the flash memory card of FIG. 11 is used;

FIG. 15 illustrates a processing flow of reading a read-enabled data area (k-1) when the read protect function is provided in the case where the flash memory card of FIG. 11 is used; and

FIG. 16 illustrates a processing flow of reading a read-disabled data area (k) when the read protect function is provided in the case where the flash memory card of FIG. 11 is used.

### DETAILED DESCRIPTION OF THE PREFERRED EMBODIMENTS

<<Memory System Using an Access Protect Definition Table>>

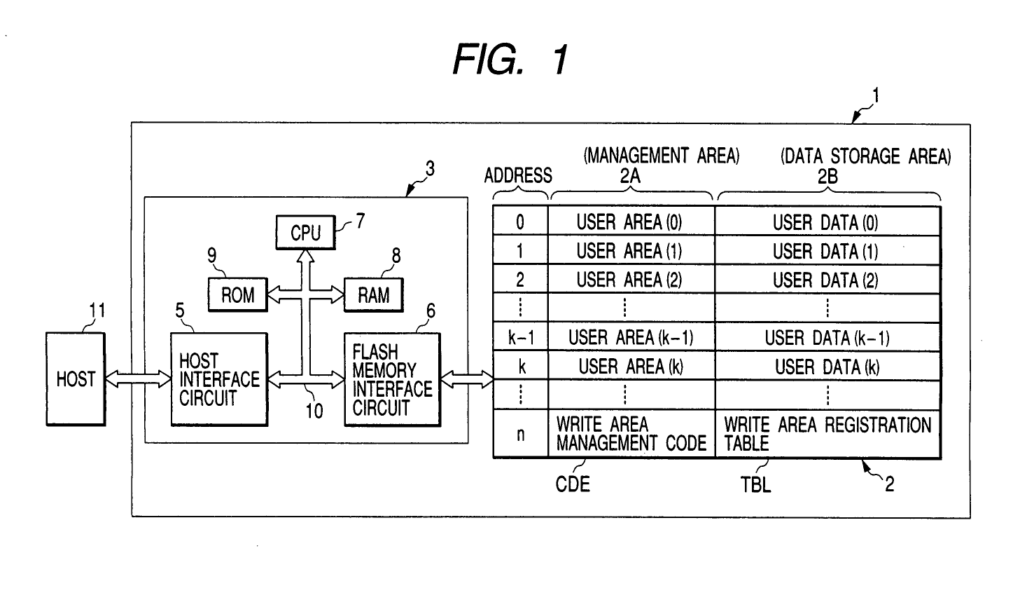

FIG. 1 shows a flash memory card as an example of a memory system according to the present invention. A flash memory card 1 shown in the drawing has a flash memory 2 (nonvolatile storage means) having data storage areas and management areas for them in units of predetermined sector addresses (physical addresses), and a flash memory controller 3 (control means) for controlling access to the flash memory 2 in response to requests from a host 11 connected outside the memory system.

The flash memory 2, although not shown, has a memory cell array with electrically erasable and programmable flash memory cells arranged in a matrix form. Although there is no particular limitation, a flash memory cell has a floating gate and a control gate separated from each other by an insulating film on a channel area. With this construction, a threshold voltage of the memory cell is increased (referred to as write), for example, by hot electron injection of electrons on to the floating gate, and a threshold voltage of the memory cell is decreased (referred to as erase) by discharging electrons injected to the floating gate by a tunnel current through a gate insulating film. The drain of the flash memory cell is connected to a bit line, the source to a source line, and the control gate to a word line. For example, an address assigned to the word line is the above described sector address. Word line selection by a sector address signal is performed by a word line selection circuit. Part of plural flash memory cells specified by a sector address is selected based on a column address signal created with a column address as a starting point by a column address counter. As a configuration of a flash memory, a configuration described in U.S. Pat. No. 6,046,936 can be adopted.

In FIG. 1, sector addresses are 0 to n. Sector addresses 0 to n-1 are used for areas for storing user data. In an area of sector address n, an access protect definition table, e.g., a write area registration table TBL is formed. The write area registration table TBL has access attribute information defining whether to permit or not access to data storage areas of sector addresses 0 to n-1 in association with physical addresses. That is, a write area management code CDE is stored in a management area 2A (n) of sector address n, and the above described write area registration table TBL is formed in a data storage area 2B (n) of sector address n.

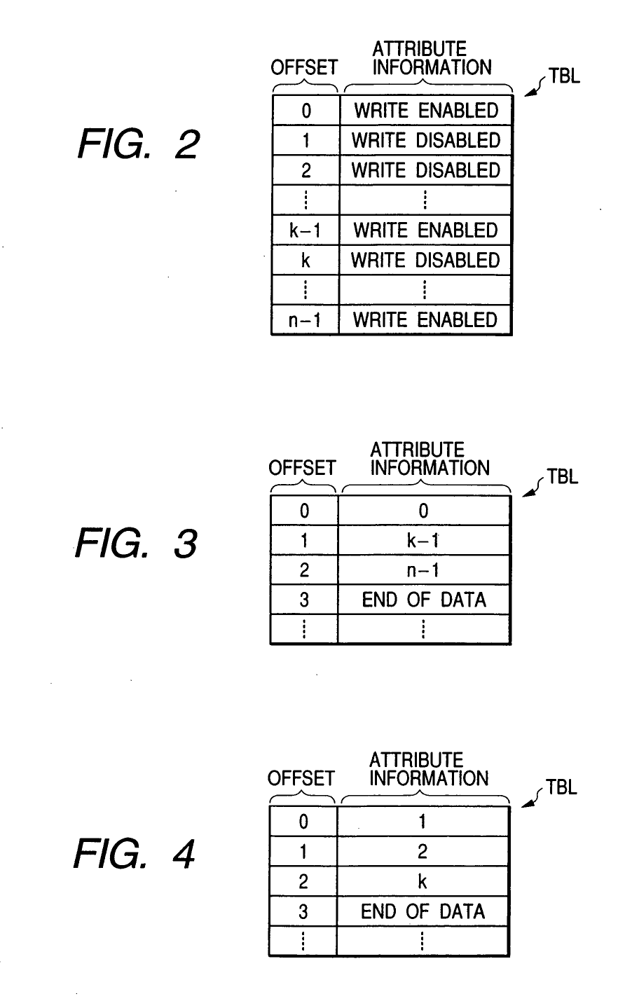

Although there is no particular limitation, the above described write area registration table TBL, as shown in FIG. 2, as access attribute information, has attribute information (write attribute information) on write protection indicating whether a write is enabled or disabled for each of sector addresses. For example, it has write attribute information in a predetermined storage unit (e.g., byte) of the data storage area of sector address n. If offset numbers of the storage unit are 0 to n-t, the offset numbers denote sector addresses, and write attribute information of each offset number is “write enabled” or “write disabled”.

Another example of the write area registration table TBL, as shown in FIG. 3, as write attribute information, has address information of write-enabled physical addresses. For example, it has write attribute information in a predetermined storage unit (e.g., byte) of the data storage area of sector address n. Specifically, if offset numbers of the storage unit are 0 to n-t, a write-enabled sector address is held for each of the offset numbers.

Yet another example of the write area registration table TBL, as shown in FIG. 4, as write attribute information, has address information of write-disabled physical addresses. For example, it has attribute information in a predetermined storage unit (e.g., byte) of the data storage area of sector address n. Specifically, if offset numbers of the storage unit are 0 to n-t, a write-disabled sector address is held for each of the offset numbers.

Although not shown, as another example of the write area registration table TBL, information indicating ranges of write-enabled or write-disabled sector addresses may be held for each of offset numbers. The ranges may be specified by specifying a start sector and an end sector, or a start sector and a sector width.

A flash memory controller 3 shown in FIG. 1, although not specially limited, has a host interface circuit 5, a flash memory interface circuit 6, CPU (central processing unit) 7, RAM (random access memory) 8, ROM (read only memory) 9, and an internal bus 10. The host interface circuit controls an interface between a host 11 such as a host system, and the flash memory controller 3. For example, specifications on the interface with the outside are IDE (Integrated Device Electronics) or the like in terms of compatibility with hard disk. The flash memory interface circuit 6 performs flash memory interface control to satisfy commands and data access specifications of the flash memory 2. The CPU 7 executes a control program held in the ROM 9 to perform external interface control by the host interface circuit 5 and memory interface control by the flash memory interface circuit 6. The RAM 8 is a work area of the CPU 7 or an area for temporarily storing data.

When a data access request is issued from the host 11 to the host interface circuit 5, the CPU 7 calculates a sector address, which is the physical address of an access target data, feeds the calculated sector address, an access command, and the like to the flash memory 2 from the flash memory interface circuit 6, and controls write, erase, or read operations on the flash memory 2. With a write operation, write data supplied from the host 11 is fed to the flash memory. With a read operation, data read from the flash memory 2 is outputted to the host 11.

<<Write Protection Using an Access Protect Definition Table>>

The flash memory controller 3 has a write protect function using attribute information of the write area registration table TBL. That is, when the flash memory controller 3 is to write to the flash memory 2 in response to a write access request from the host 11, if an access target is not sector address n, it refers to attribute information of the write area registration table TBL, and if a sector to write to is write-enabled, makes a write to the sector; if the sector to write to is write-disabled, it rejects a write to the sector. If a sector to be accessed is sector address n, the flash memory controller 3 rejects a write to the flash memory 2. If the flash memory controller 3 is instructed to modify write attribute information by the host 11, it modifies attribute information of the write area registration table TBL of sector address n according to the instruction.

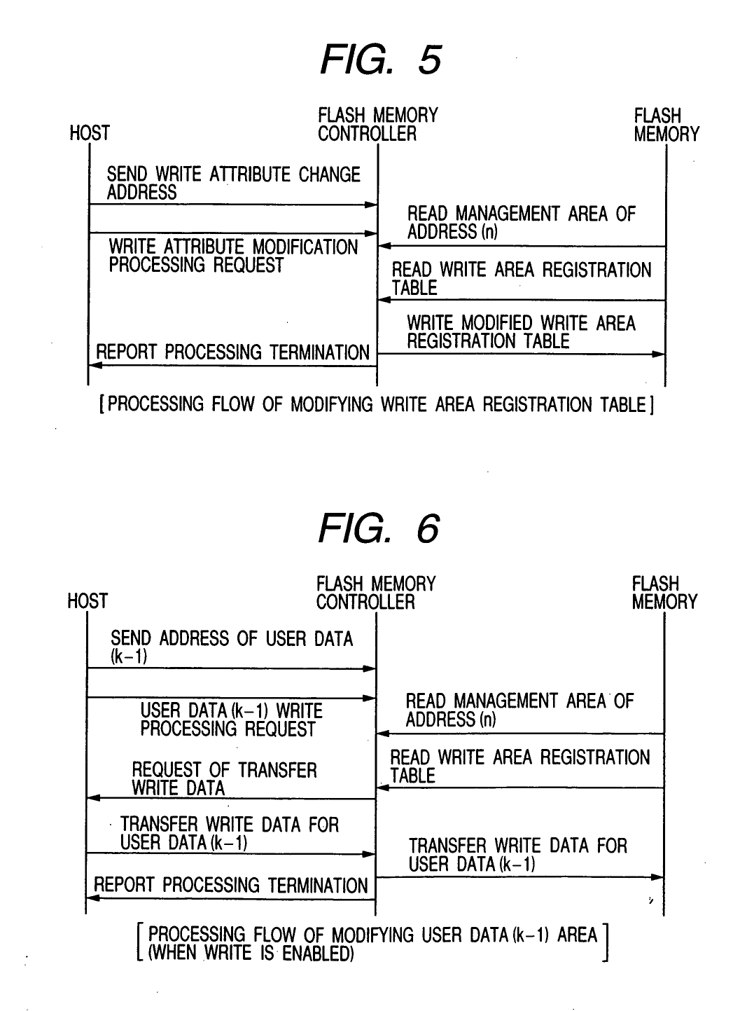

FIG. 5 shows a processing flow of modifying the write area registration table TBL. The host 11 sends the address of the write area registration table TBL to the flash memory controller 3 and issues a request to modify write attribute information. In response to the request, the flash memory controller 3 reads data from a management area 2A (n) of sector address n and reads the write area registration table TBL upon recognizing the write area management code CDE. The flash memory controller 3 modifies the read write area registration table TBL according to a modification request from the host 11 and writes the modified write area registration table TBL back to the data storage area 2B (n) of sector address n. Upon completion of the modification of the write area registration table TBL, the flash memory controller 3 informs the host 11 of processing termination.

FIG. 6 shows a processing flow of modifying a write-enabled data area (k-1). The host 11 sends the address of data (k-1) to be modified to the flash memory controller 3, and issues a write request. In response to the request, the flash memory controller 3 reads data from the management area 2A (n) of sector address n and reads the write area registration table TBL upon recognizing the write area management code CDE. Upon recognizing that write attribute information corresponding to sector address (k-1) of the write area registration table TBL is “write enabled”, the flash memory controller 3 requests the host 11 to transfer write data. In response to the request, the host 11 transfers write data to the flash memory controller 3. The flash memory controller 3 supplies the write data to the flash memory 2 to instruct the flash memory 2 to replace the sector address (k-1) by the data. Upon detection of completion of the writing by the flash memory 2 through polling or the like, the flash memory controller 3 informs the host 11 of processing termination.

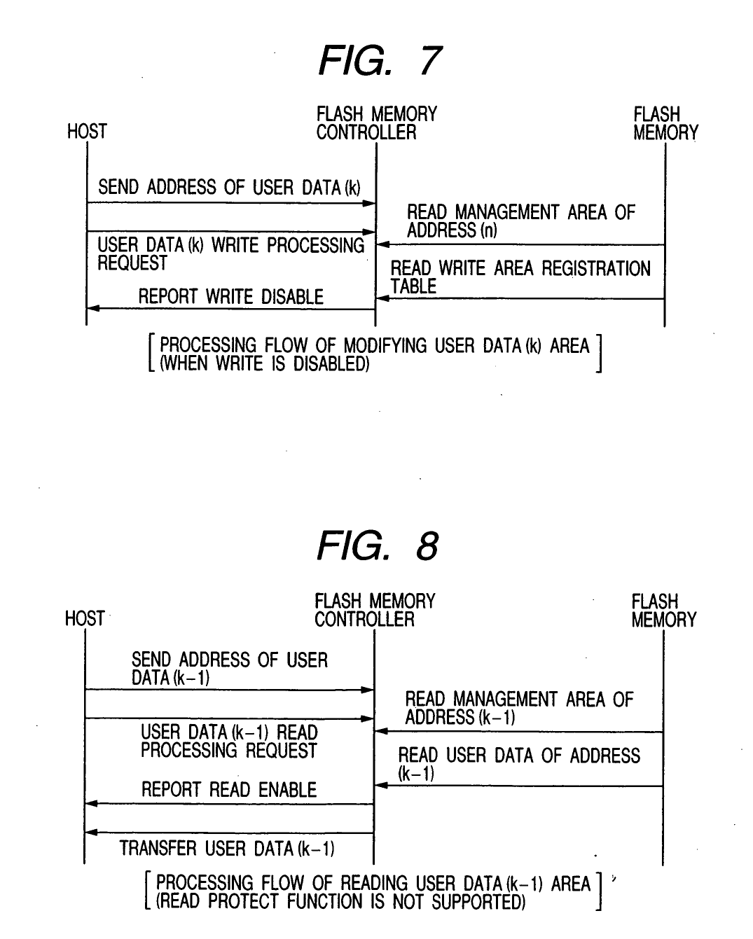

FIG. 7 shows a processing flow of modifying a write-disabled data area (k). The host 11 sends the address of data (k) to be modified to the flash memory controller 3, and issues a write request. In response to the request, the flash memory controller 3 reads data from the management area 2A (n) of sector address n and reads the write area registration table TBL upon recognizing the write area management code CDE. Upon recognizing that write attribute information corresponding to sector address (k) of the write area registration table TBL is “write disabled”, the flash memory controller 3 informs the host 11 by a predetermined error code that modification is impossible, and terminates processing.

<<Read protection using an access protect definition table>> The memory system 1 may have a read protect function alone or in combination with the write protect function. That is, an access protect definition table, e.g., a read area registration table (not shown) is formed in an area of sector address n. The read area registration table has access attribute information defining whether to permit or not access to data storage areas of sector addresses 0 to n-1 in association with physical addresses. That is, a read area management code CDE is stored in a management area 2A (n) of sector address n, and the above described read area registration table TBL (not shown) is formed in a data storage area 2B (n) of sector address n.

The above described read area registration table TBL, as described in FIG. 2 has, as access attribute information, attribute information (read attribute information) on read protection indicating whether a read is enabled or disabled for each of sector addresses. For example, it has read attribute information in a predetermined storage unit (e.g., byte) of a data storage area of sector address n. Specifically, if offset numbers of the storage unit are 0 to n-t, the offset numbers denote sector addresses, and read attribute information of each offset number is “read enabled” or “read disabled”.

Another example of the read area registration table TBL, as described in FIG. 3, as read attribute information, has address information of read-enabled physical addresses. For example, it has read attribute information in a predetermined storage unit (e.g., byte) of a data storage area of sector address n. Specifically, if offset numbers of the storage unit are 0 to n-t, a read-enabled sector address is held for each of the offset numbers.

Another example of the read area registration table TBL, as described in FIG. 4, as read attribute information, has address information of read-disabled physical addresses. For example, it has attribute information in a predetermined storage unit (e.g., byte) of a data storage area of sector address n. Specifically, if offset numbers of the storage unit are 0 to n-t, a read-disabled sector address is held for each of the offset numbers.

Although not shown, as another example of the read area registration table TBL, information indicating ranges of read-enabled or read-disabled sector addresses may be held for each of offset numbers. The ranges may be specified by specifying a start sector and an end sector, or a start sector and a sector width.

The flash memory controller 3 has a read protect function using attribute information of the read area registration table TBL (not shown). That is, when the flash memory controller 3 is to make a read from the flash memory 2 in response to a data read access request from the host 11, if an access target is not sector address n, it refers to attribute information of the read area registration table TBL. If a sector to read from is read-enabled, the flash memory controller 3 makes a read from the sector, and if the sector to read from is read-disabled, it rejects a read from the sector. Although there is no particular limitation, if a sector to be accessed is sector address n, the flash memory controller 3 rejects a read from the flash memory 2. If the flash memory controller 3 is instructed to modify write attribute information by the host 11, it modifies attribute information of the read area registration table TBL of sector address n according to the instruction. A processing flow of modifying the write area registration table TBL is the same as described in FIG. 5, and omitted here.

FIG. 8 shows a processing flow of read operation when the read protect function is not provided. The host 11 sends the address of data (k-1) to be read to the flash memory controller 3, and issues a read request. In response to the request, the flash memory controller 3 reads data from a management area 2A (k-1) of sector address (k-1) and, if a sector concerned is valid, reads data from a data area of sector address (k-1). The flash memory controller 3 informs the host 11 that reading is possible, and then outputs the read data to the host 11.

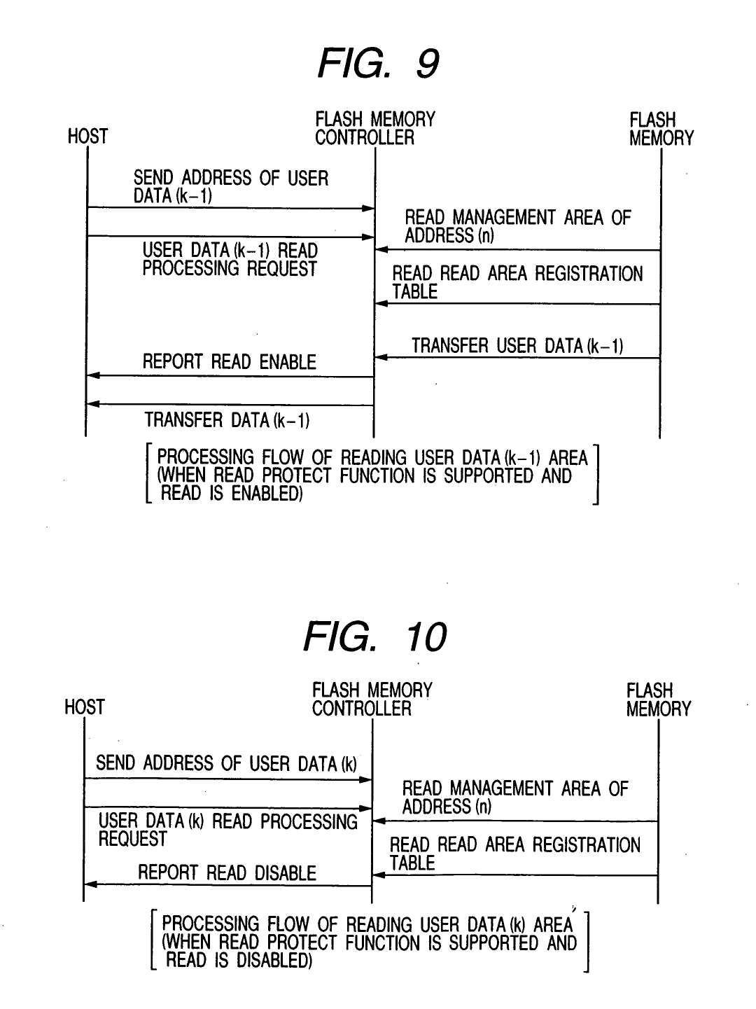

FIG. 9 shows a processing flow of reading a read-enabled data area (k-1) when the read protect function is provided. The host 11 sends the address of data (k-1) to be read to the flash memory controller 3, and issues a read request. In response to the request, the flash memory controller 3 reads data from the management area 2A (n) of sector address n and, reads the read area registration table upon recognizing the read area management code. Upon recognizing that read attribute information corresponding to sector address (k-1) of the read area registration table is “read enabled”, the flash memory controller 3 reads data of sector address (k-1) from the flash memory 2. The flash memory controller 3 informs the host 11 that reading is possible, and then outputs the read data to the host 11.

FIG. 10 shows a processing flow of reading a read-disabled data area (k) when the read protect function is provided. The host 11 sends the address of data (k) to be read to the flash memory controller 3, and issues a read request. In response to the request, the flash memory controller 3 reads data from the management area 2A (n) of sector address n and, reads the read area registration table upon recognizing the read area management code. Upon recognizing that write attribute information corresponding to sector address (k) of the read area registration table is “read disabled”, the flash memory controller 3 informs the host 11 by a predetermined error code that reading is impossible, and terminates processing.

The flash memory card 1 using the access protect definition table has an access protect function such as write protection and read protection. The access protect function is maintained even if an abnormal condition occurs in the host 11 such as a host device or host system that manages the flash memory card 1 or controls it as a peripheral circuit. Therefore, even if the system or OS becomes uncontrollable due to an abnormal condition of the host 11 and undesirable write and erase requests are issued, if an instruction to reset the access protect function of the flash memory card 1 is not made at the same time, the undesirable write and erase requests are not executed. In short, although the write attribute modification processing described in FIG. 5 must be undesirably performed, it is actually impossible that such processing is performed as a result of uncontrollable run. Consequently, the above described write protection helps to significantly reduce the possibility that stored information is undesirably changed due to an abnormal condition in an upstream or superior side of a system such as an OS. Also, the above described read protection helps to significantly reduce the possibility that stored information is undesirably read due to an abnormal condition in an upstream or superior side of a system such as an OS. Furthermore, since the write area registration table and the read area registration table define whether to permit or not access to data storage areas 2B in association with physical addresses, access protection can be applied not only on a file basis but also to part of files and the like.

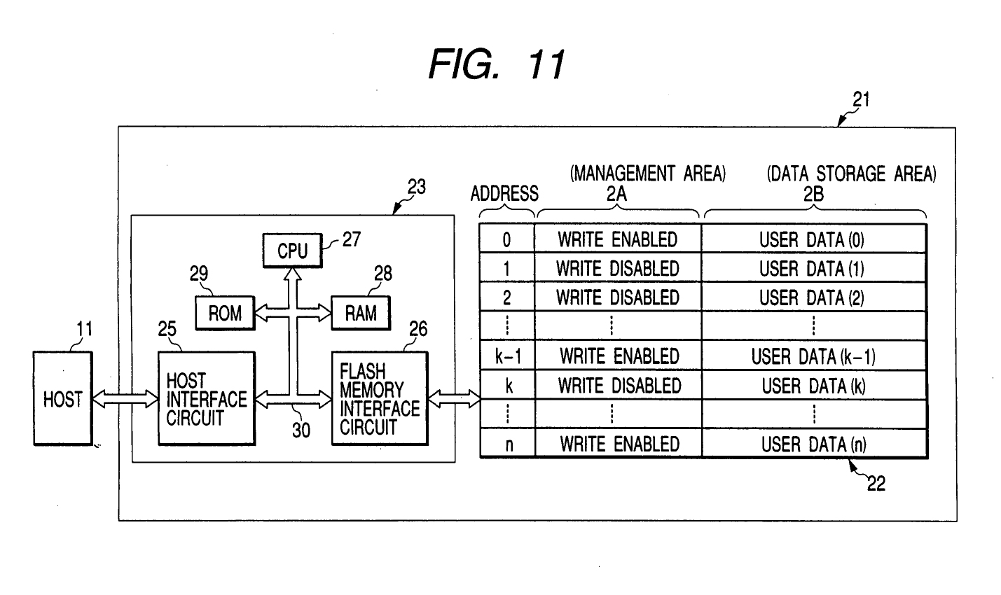

Since the read protect function of the present invention allows rewriting, if the function is used, secret information, e.g., log information of a series of PC processes can be stored that is used by only a PC such as a host device in which a memory card is mounted, and cannot be disclosed to third parties.

<<Memory system using management areas for access protection>> FIG. 11 shows a flash memory card as another example of the memory system of the present invention. In FIG. 11, a flash memory card 21 includes a flash memory (nonvolatile storage means) 22 having data storage areas and management areas for them in units of predetermined sector addresses (physical addresses), and a flash memory controller 23 (control means) for controlling access to the flash memory 22 in response to requests from a host external to the memory system.

The circuit configuration of the flash memory 22 is the same as that of the flash memory 2, except that management areas 22A and data storage areas 22B are used in different modes. In FIG. 11, sector addresses 0 to n are used as areas for storing user data. Management areas 22A (0) to 22A (n) of the sector addresses have access attribute information defining whether to permit or not access to corresponding data storage areas 22B (0) to 22B (n). Access attribute information shown in FIG. 11 is write attribute information indicating that write is enable or write is disabled.

A flash memory controller 23, although not specially limited, like the flash memory controller in FIG. 1, has a host interface circuit 25, a flash memory interface circuit 26, CPU (central processing unit) 27, RAM (random access memory) 28, ROM (read only memory) 29, and an internal bus 30. A point of difference from the flash memory controller in FIG. 1 is the access protect function executed by the CPU 27, and other functions are the same as those in FIG. 1 and therefore a description of them is omitted.

<<Write Protection Using Management Areas>> The flash memory controller 23 has a write protect function using attribute information held in the management areas of the sectors. That is, when the flash memory controller 23 is to write to the flash memory 22 in response to a data write access request from the host 11, it refers to write attribute information of the management areas, and if a sector to write to is write-enabled, makes a write to the sector; if the sector to write to is write-disabled, it rejects a write to the sector. If the flash memory controller is instructed to modify write attribute information by the host 11, it modifies write attribute information of a specified sector address n according to the instruction.

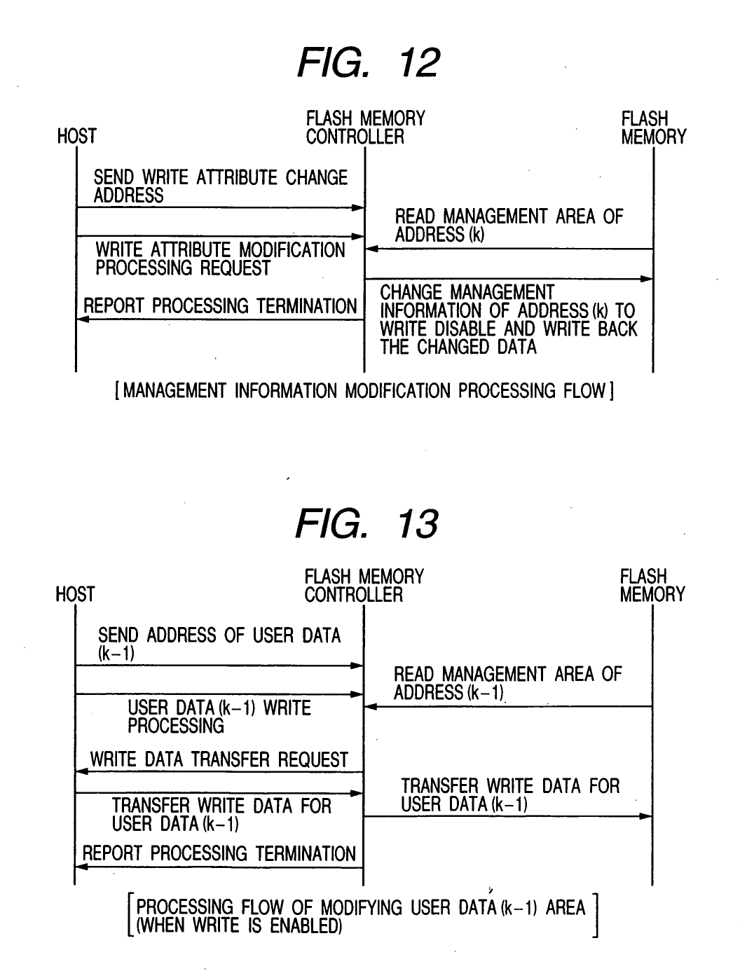

FIG. 12 shows a processing flow of modifying write attribute information. The host 11 sends the sector address (k) to modify write attribute to the flash memory controller 23 and issues a request to modify write attribute. In response to the request, the flash memory controller 23 reads data from a management area 22A (k) of sector address (k). The flash memory controller 23 modifies the read data of the management area 22A (k) according to a modification request from the host 11, and writes back the changed data to the management area 22A (k) of sector address (k). Upon completion of the modification of the management area 22A (k), the flash memory controller 23 informs the host 11 of processing termination.

FIG. 13 shows a processing flow of modifying a write-enabled data area (k-1). The host 11 sends the address of data (k-1) to be modified to the flash memory controller 23, and issues a write request. In response to the request, the flash memory controller 23 reads data from the management area 22A (n) of sector address (k-1), and upon recognizing that write attribute information contained therein is “write enabled”, requests the host 11 to transfer write data. In response to the request, the host 11 transfers write data to the flash memory controller 23. The flash memory controller 23 supplies the write data to the flash memory 22 to instruct the flash memory 22 to replace the sector address (k-1) by the data. Upon detection of completion of the writing by the flash memory 22 through polling or the like, the flash memory controller 23 informs the host 11 of processing termination.

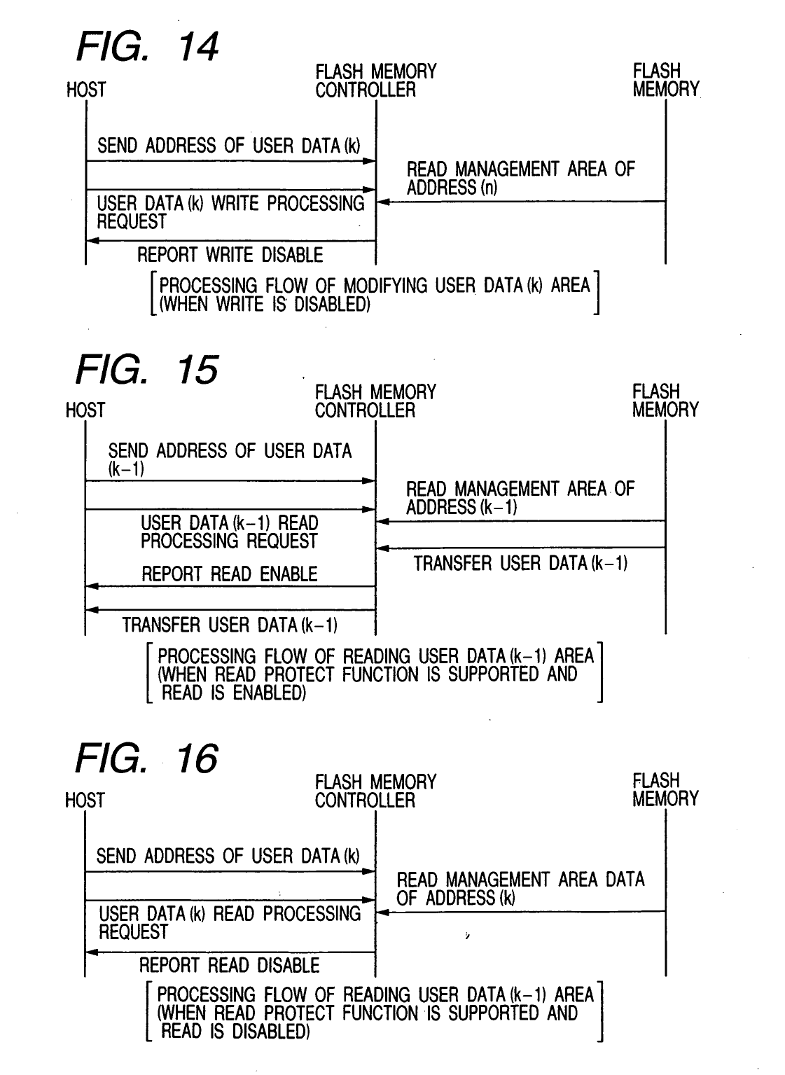

FIG. 14 shows a processing flow of modifying a write-disabled data area (k). The host 11 sends the address of data (k) to be modified to the flash memory controller 23, and issues a write request. In response to the request, the flash memory controller 23 reads data from the management area 22A (k) of sector address (k), and upon recognizing that write attribute information contained therein is “write disabled”, informs the host 11 by a predetermined error code that modification is impossible, and terminates processing.

<<Read protection using management areas>> The memory system 21 may have a read protect function alone or in combination with the write protect function. Management areas 22A (0) to 22A (n) of the sector addresses have, as access attribute information, read attribute information indicating whether corresponding data storage areas 22B(0) to 22B(n) are read-enabled or read-disabled.

The flash memory controller 23 has a read protect function using the read attribute information (not shown). That is, when the flash memory controller 23 is to make a read from the flash memory 22 in response to a data read access request from the host 11, it refers to read attribute information held in a management area of the sector address to make an access to, and if a read is enabled, reads the sector; if a read is disabled, it rejects a read from the sector. If the flash memory controller 23 is instructed to modify read attribute information by the host 11, it modifies attribute information held in a management area of a sector address concerned according to the instruction. A processing flow of modifying the read attribute information is the same as described in FIG. 12, and omitted here.

FIG. 15 shows a processing flow of reading a read-enabled data area (k-1) when the read protect function is provided. The host 11 sends the address of data (k-1) to be read to the flash memory controller 23, and issues a read request. In response to the request, the flash memory controller 23 reads data from the management area 22A (k-1) of sector address (k-1) and, upon recognizing that read attribute information is “read enabled”, reads data of sector address (k-1) from the flash memory 22. The flash memory controller 23 informs the host 11 that reading is possible, and then outputs the data read from the data area to the host 11.

FIG. 16 shows a processing flow of reading a read-disabled data area (k) when the read protect function is provided. The host 11 sends the address of data (k) to be read to the flash memory controller 23, and issues a read request. In response to the request, the flash memory controller 23 reads data from the management area 22A (k) of sector address k and, and upon recognizing that read attribute information is “read disabled”, informs the host 11 by a predetermined error code that reading is impossible, and terminates processing.

A processing flow of read operation when the read protect function is not provided is basically the same as in FIG. 15, except that read attribute information is judged.

In the flash memory system 21 providing access protection by using the management areas of the sectors, the flash memory system 21 itself has the access protect function such as write protection and read protection, and the access protect function is maintained even if an abnormal condition occurs in the host 11 that manages the flash memory system 21 or controls it as a peripheral circuit. Therefore, the write protection helps to significantly reduce the possibility that stored information is undesirably changed due to an abnormal condition in an upstream or superior side of a system such as an OS. The read protection helps to significantly reduce the possibility that stored information is undesirably read due to an abnormal condition in an upstream or superior side of a system such as an OS. Furthermore, since the write attribute information and the read attribute information are held in management areas of sectors, access protection can be applied not only on a file basis but also to part of files and the like.

Since the read protect function of the present invention allows rewriting, if the function is used, secret information can be stored that is used by only a PC and cannot be disclosed to third parties.

A description is made of comparison with the use of the access protect definition table TBL. When management areas of individual physical addresses in a flash memory are provided with attribute information for access protection to check the setting of access protection for the flash memory, all the physical addresses must be accessed for the checking. On the other hand, in cases where the access protect definition table TBL is used, efficiently, the table has only to be accessed.

Although the invention made by the inventor has been described in detail based on preferred embodiments, it goes without saying that the present invention is not limited to the embodiments and various modifications may be made without departing from the spirit and scope of the present invention.

For example, it is possible to transfer the contents of the access protect definition table from a flash memory to RAM to refer to access attribute information of the access protect definition table transferred to the RAM. In this case, when the access attribute information is modified, it is desirable to reflect the modification contents not only in the access attribute information held on the RAM but also in the access protect definition table on the flash memory. In contrast to this, in cases where modifications are made only on the RAM and the access protect definition table on the flash memory is collectively modified after power is turned off, modification contents of the access protect definition table may be undesirably lost.

In an access command inputted to the memory system from the outside, an address identifying an access target may be a logical address or file name recognized by a host device that manages the memory system or controls access to the memory system. When access attribute information or stored information of the access protect definition table is modified, external devices may specify a physical address of the memory system.

Write protection of the present invention can also be used in cases where rewritable flash memory cards are ultimately delivered as ROM products. For example, it is used for storage media of electronic dictionaries. In this case, protection setting or resetting for the access protect definition table is performed using a special writing device by, e.g., a vendors of the memory cards.

The memory system of the present invention is not limited to flash memory cards and can be formed on a data processing circuit board such as a PC board. The memory system is not limited to a configuration using a semiconductor nonvolatile memory. Magnetic disk may be adopted as nonvolatile storage means to realize a memory system as a hard disk unit.

Effects obtained by typical inventions disclosed by the present patent application are briefly described below.

The memory system itself possesses access attribute information defining whether to permit or not a write to and a read from to data storage areas in association with addresses to implement an access protect function for write and read. Therefore, the access protect function is maintained even if an abnormal condition occurs in a host device or host system that manages the memory system or controls it as a peripheral circuit. Therefore, even if the system or OS becomes uncontrollable due to an abnormal condition in the host device or host system and undesirable write and erase requests are issued, if an instruction to reset the access protect function of the memory system is not made at the same time, the undesirable write and erase requests are not executed. This helps to significantly reduce the possibility that stored information is undesirably changed due to an abnormal condition in an upstream or superior side of a system such as an OS. Also, this helps to significantly reduce the possibility that stored information is undesirably read due to an abnormal condition in an upstream or superior side of a system such as an OS. Furthermore, since the access attribute information defines whether to permit or not access to data storage areas in association with physical addresses, access protection can be applied not only on a file basis but also to part of files and the like.

Since the read protect function of the present invention allows rewriting, if the function is used, secret information can be stored that is used by only a PC and cannot be disclosed to third parties.

1-11. (canceled)

12. A nonvolatile memory apparatus comprising:
a control circuit; and
a nonvolatile memory including a plurality of nonvolatile memory cells, and divided into a plurality of address blocks, each of which includes corresponding ones of said nonvolatile memory cells,
wherein each of the nonvolatile memory cells is capable of storing data by changing a threshold voltage thereof,
wherein first ones of the nonvolatile memory cells are used for storing a management table, which includes management information for specifying whether it is acceptable or not to access to an address block,
wherein when the control circuit receives an access command accompanied by address information from outside, the control circuit refers to the management information in the management table for an address block corresponding to the address information, allows access to the corresponding address block in accordance with the access command when the management information indicates that access to the corresponding address block is acceptable, and inhibits access to the corresponding address block notwithstanding the access command when the management information indicates that access to the corresponding address block is not acceptable.

13. A nonvolatile memory apparatus according to claim 12,
wherein when the control circuit receives an attribute change command accompanied by address information from outside, the control circuit changes the management information corresponding to the address information from acceptable to not acceptable or from not acceptable to acceptable.

14. A nonvolatile memory apparatus according to claim 13,
wherein the management information includes read acceptance information, wherein when the control circuit receives a read command as the access command accompanied by read address information, the control circuit refers to the read acceptance information for an address block corresponding to the read address information, allows read access to the address block corresponding to the read address information if the read acceptance information indicates that read access is acceptable, and inhibits the read access if the read acceptance information indicates that the read access is not acceptable.

15. A nonvolatile memory apparatus according to claim 14,
wherein the management information includes a write acceptance information, wherein when the control circuit receives a write command as the access command accompanied by write address information, the control circuit refers to the write acceptance information for an address block corresponding to the write address information, allows write access to the address block corresponding to the write address information if the write acceptance information indicates that write access is acceptable, and inhibits the write access if the write acceptance information indicates that the write access is not acceptable.

16. A nonvolatile memory apparatus according to claim 15,
wherein each of the read acceptance information and the write acceptance information can be changed by a respective attribute change command.

17. A nonvolatile memory apparatus according to claim 16,
wherein the nonvolatile memory further includes a plurality of word lines, each of which is coupled with corresponding ones of the nonvolatile memory cells,
wherein each address block corresponds to a group of nonvolatile memory cells coupled to one word line.
